(19) United States
(12) Patent Application Publication
(10) Pub. No.: US 2023/0153674 A1
(43) Pub. Date: May 18, 2023

(54) ESTIMATION OF CLASSICAL CAPACITY OF QUANTUM CHANNEL

(71) Applicant: BEIJING BAIDU NETCOM SCIENCE TECHNOLOGY CO., LTD., Beijing (CN)

(72) Inventors: Xin WANG, Beijing (CN); Xuanqiang ZHAO, Beijing (CN)

(73) Assignee: BEIJING BAIDU NETCOM SCIENCE TECHNOLOGY CO., LTD., Beijing (CN)

(21) Appl. No.: 18/094,304

(22) Filed: Jan. 6, 2023

(30) Foreign Application Priority Data
Jan. 10, 2022 (CN) 202210021934.8

(51) Int. Cl. G06N 10/20; G06N 10/60

(52) U.S. Cl. CPC G06N 10/20; G06N 10/60

(57) ABSTRACT

A method is provided. The method includes: determining m first parameterized quantum circuits and a second parameterized quantum circuit of an m-dimensional quantum system; obtaining m first quantum states obtained after the first parameterized quantum circuits act on an initial quantum state and m second quantum states obtained after the quantum channel acts on the m first quantum states; obtaining a quantum state matrix obtained after the second parameterized quantum circuit acts on the initial quantum state, where diagonal elements of the matrix correspond to the first quantum states to constitute an ensemble; optimizing parameters of the parameterized quantum circuits by minimizing a loss function, where the loss function is determined based on Holevo information of the quantum channel at the current ensemble; and determining the Holevo information, obtained after the optimization, of the quantum channel as an estimated value of the classical capacity of the quantum channel.

### CROSS REFERENCE TO RELATED APPLICATIONS

The present application claims priority to Chinese Patent Application No. 202210021934.8 filed on Jan. 10, 2022, the content of which is hereby incorporated by reference in its entirety for all purposes.

### TECHNICAL FIELD

The present disclosure relates to the field of computers, in particular to the technical field of quantum computers, and specifically to a method and an apparatus for estimating a classical capacity of a quantum channel, an electronic device, a computer-readable storage medium, and a computer program product.

### BACKGROUND

Information transmission exists in all aspects of social production and life. Daily telephone and email communications are processes of classical information transmission. Nowadays, the quantum computer technology is developing rapidly, and the use of quantum technology to transmit information has also aroused great interest of researchers. In the information theory, the transmission of information is characterized by a channel, and a capacity of the channel represents a maximum rate at which information can be reliably transmitted by using the channel In the quantum information theory, the transmission of information is characterized by a quantum channel. A classical capacity of the quantum channel represents a maximum rate at which classical information can be reliably transmitted by using the quantum channel. At present, classical capacities of quantum channels are mostly computed by mathematical simplification and operations, and there are few systematic solutions for general quantum channels.

### SUMMARY

The present disclosure provides a method and an apparatus for estimating a classical capacity of a quantum channel, an electronic device, a computer-readable storage medium, and a computer program product.

According to an aspect of the present disclosure, there is provided a method for estimating a classical capacity of a quantum channel, the method including: determining m n-qubit first parameterized quantum circuits and a second parameterized quantum circuit that acts on an m-dimensional quantum system, where n is the number of qubits of the quantum channel, m is the number of quantum states in a preset ensemble, and m and n are positive integers; obtaining m first quantum states obtained after the m first parameterized quantum circuits separately act on an first initial quantum state; obtaining m second quantum states obtained after the quantum channel separately acts on the m first quantum states; obtaining a quantum state matrix obtained after the second parameterized quantum circuit acts on a second initial quantum state, where m diagonal elements of the quantum state matrix as probability values are in a one-to-one correspondence with the m first quantum states to constitute a current ensemble; optimizing parameters of the m first parameterized quantum circuits and the second parameterized quantum circuit by minimizing a loss function, where the loss function is determined based on Holevo information of the quantum channel at the current ensemble, and the Holevo information is determined based on the m second quantum states and corresponding probability values; and determining the Holevo information, obtained after the loss function is minimized, of the quantum channel as an estimated value of the classical capacity of the quantum channel.

According to another aspect of the present disclosure, there is provided an information transmission method based on a quantum channel, the method including: obtaining an ensemble corresponding to Holevo information of the quantum channel; obtaining classical information to be transmitted to encode the classical information onto a corresponding quantum state in the ensemble; transmitting the encoded quantum state through the quantum channel to obtain a transmitted quantum state; and decoding the transmitted quantum state to obtain transmitted classical information. The ensemble corresponding to the Holevo information is obtained by performing operations comprising: determining m n-qubit first parameterized quantum circuits and a second parameterized quantum circuit that acts on an m-dimensional quantum system, wherein n is the number of qubits of the quantum channel, m is the number of quantum states in a preset ensemble, and m and n are positive integers; obtaining m first quantum states obtained after the m first parameterized quantum circuits separately act on an first initial quantum state; obtaining m second quantum states obtained after the quantum channel separately acts on the m first quantum states; obtaining a quantum state matrix obtained after the second parameterized quantum circuit acts on a second initial quantum state, wherein m diagonal elements of the quantum state matrix as probability values are in a one-to-one correspondence with the m first quantum states to constitute a current ensemble; optimizing parameters of the m first parameterized quantum circuits and the second parameterized quantum circuit by minimizing a loss function, wherein the loss function is determined based on Holevo information of the quantum channel at the current ensemble, and the Holevo information is determined based on the m second quantum states and corresponding probability values; and determining the Holevo information, obtained after the loss function is minimized, of the quantum channel as an estimated value of the classical capacity of the quantum channel.

According to another aspect of the present disclosure, there is provided an electronic device, including: a memory storing one or more programs configured to be executed by one or more processors, the one or more programs including instructions for causing the electronic device to perform operations comprising: determining m n-qubit first parameterized quantum circuits and a second parameterized quantum circuit that acts on an m-dimensional quantum system, wherein n is the number of qubits of the quantum channel, m is the number of quantum states in a preset ensemble, and m and n are positive integers; obtaining m first quantum states obtained after the m first parameterized quantum circuits separately act on an first initial quantum state; obtaining m second quantum states obtained after the quantum channel separately acts on the m first quantum states; obtaining a quantum state matrix obtained after the second parameterized quantum circuit acts on a second initial quantum state, wherein m diagonal elements of the quantum state matrix as probability values are in a one-to-one correspondence with the m first quantum states to constitute a current ensemble; optimizing parameters of the m first parameterized quantum circuits and the second parameterized quantum circuit by minimizing a loss function, wherein the loss function is determined based on Holevo information of the quantum channel at the current ensemble, and the Holevo information is determined based on the m second quantum states and corresponding probability values; and determining the Holevo information, obtained after the loss function is minimized, of the quantum channel as an estimated value of the classical capacity of the quantum channel.

It should be understood that the content described in this section is not intended to identify critical or important features of the embodiments of the present disclosure, and is not used to limit the scope of the present disclosure. Other features of the present disclosure will be easily understood through the following description.

### BRIEF DESCRIPTION OF THE DRAWINGS

The accompanying drawings exemplarily show embodiments and form a part of the specification, and are used to explain exemplary implementations of the embodiments together with a written description of the specification. The embodiments shown are merely for illustrative purposes and do not limit the scope of the claims. Throughout the accompanying drawings, the same reference numerals denote similar but not necessarily same elements.

FIG. 1 is a flowchart of a method for estimating a classical capacity of a quantum channel according to an embodiment of the present disclosure;

FIG. 2 is a flowchart of an information transmission method based on a quantum channel according to an embodiment of the present disclosure;

FIG. 3 is a structural block diagram of an apparatus for estimating a classical capacity of a quantum channel according to an embodiment of the present disclosure;

FIG. 4 is a structural block diagram of an information transmission apparatus based on a quantum channel according to an embodiment of the present disclosure; and

FIG. 5 is a structural block diagram of an exemplary electronic device that can be used to implement an embodiment of the present disclosure.

### DETAILED DESCRIPTION OF EMBODIMENTS

Exemplary embodiments of the present disclosure are described below in conjunction with the accompanying drawings, where various details of the embodiments of the present disclosure are included to facilitate understanding, and should only be considered as exemplary. Therefore, those of ordinary skill in the art should be aware that various changes and modifications can be made to the embodiments described herein, without departing from the scope of the present disclosure. Likewise, for clarity and conciseness, the description of well-known functions and structures is omitted in the following description.

In the present disclosure, unless otherwise stated, the terms “first”, “second”, etc., used to describe various elements are not intended to limit the positional, temporal or importance relationship of these elements, but rather only to distinguish one component from another. In some examples, the first element and the second element may refer to the same instance of the element, and in some cases, based on contextual descriptions, the first element and the second element may also refer to different instances.

The terms used in the description of the various examples in the present disclosure are merely for the purpose of describing particular examples, and are not intended to be limiting. If the number of elements is not specifically defined, there may be one or more elements, unless otherwise expressly indicated in the context. Moreover, the term “and/or” used in the present disclosure encompasses any of and all possible combinations of listed items.

The embodiments of the present disclosure will be described below in detail with reference to the accompanying drawings.

Nowadays, with the rapid development of the quantum computer technology, information transmission based on the quantum technology has gradually applied to reality from theory. In the communication theory, the transmission of information is characterized by a channel, and a capacity of the channel represents a maximum rate at which information can be reliably transmitted by using the channel. In the quantum information theory, the transmission of information is characterized by a quantum channel, that is, the quantum channel is the main research object of information transmission, and classical information is one of the most common forms of information.

A classical capacity of the quantum channel represents a maximum rate at which classical information can be reliably transmitted by using the quantum channel A classical capacity C( [symbol] ) of a quantum channel N is shown by formula (1):

$$C ( 𝒩 ) = {lim}_{n \to ∞} \frac{𝒳 ( {𝒩}^{⊗ n} )}{n} \qquad formula ( 1 )$$

Herein, [symbol] ^{⊗n} represents a quantum channel composed of a tensor product of n quantum channels [symbol] , and χ( [symbol] ) represents a Holevo capacity of the quantum channel [symbol] ^{⊗n}.

At present, classical capacities of quantum channels are mostly computed by mathematical simplification and operations, and there are few systematic solutions for general quantum channels. For example, an upper bound of a classical capacity of a general quantum channel can be computed based on semi-definite programming, and is also the upper bound of a Holevo capacity of the quantum channel. However, because the upper bounds of the classical capacity and Holevo capacity of the quantum channel are given, the capacity of the quantum channel may be overestimated, and it cannot be known at least how much classical information can be reliably transmitted when the quantum channel is actually used.

The classical capacity of the quantum channel characterizes a maximum rate at which the quantum channel can reliably transmit the classical information, while the Holevo capacity of the quantum channel characterizes a maximum rate at which the classical information can be reliably transmitted by using the quantum channel without using quantum entanglement encoding. It can be known by estimating the two values how much classical information can be reliably transmitted by using the quantum channel in different scenarios.

It should be noted that the Holevo capacity has superadditivity, that is, for two quantum channels [symbol] and [symbol] , [symbol] ≥ [symbol] + [symbol] . Thus, according to formula (1), the form of formula (2) can be obtained.

$$C ( 𝒩 ) = {lim}_{n \to ∞} \frac{𝒳 ( {𝒩}^{⊗ n} )}{n} \geq {lim}_{n \to ∞} \frac{n 𝒳 ( 𝒩 )}{n} = 𝒳 ( 𝒩 ) \qquad formula ( 2 )$$

That is, a Holevo capacity χ( [symbol] ) of a quantum channel N gives a lower bound of the classical capacity C( [symbol] ) of the channel.

Therefore, the classical capacity of the quantum channel [symbol] can be estimated by estimating its Holevo capacity, as shown in formula (3).

$$𝒳 ( 𝒩 ) := {max}_{\{ {p}_{j} , {ρ}_{j} \}} ( S ( {\sum }_{j} {p}_{j} 𝒩 ( {ρ}_{j} ) ) - {\sum }_{j} {p}_{j} S ( 𝒩 ( {ρ}_{j} ) ) ) \qquad formula ( 3 )$$

Herein, {pⱼ,ρⱼ} is an ensemble composed of a number of quantum states ρⱼ, and S(ρ)=−Tr[ρ log 2 ρ] is a von Neumann entropy of the quantum state ρ. The quantum state ρ can be mathematically represented by a density matrix, and Tr represents obtaining a trace of the matrix. A Holevo capacity gives a lower bound of a classical capacity of a quantum channel, which represents a maximum rate at which classical information can be reliably transmitted by using the channel without using quantum entanglement resources. It can be learned that the Holevo capacity of the quantum channel is computed to find an ensemble so that Holevo information of the quantum channel at the ensemble has a maximum value. That is, the Holevo capacity of the quantum channel can be referred to as the maximum value of its Holevo information.

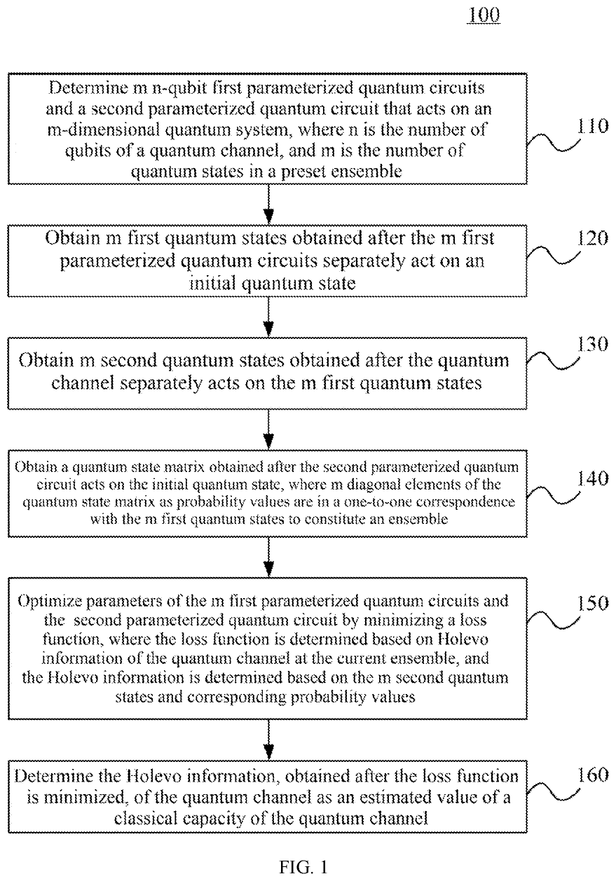

In view of the above, according to an embodiment of the present disclosure, as shown in FIG. 1, there is provided a method 100 for estimating a classical capacity of a quantum channel, the method including: determining m n-qubit first parameterized quantum circuits and a second parameterized quantum circuit that acts on an m-dimensional quantum system, where n is the number of qubits of the quantum channel, and m is the number of quantum states in a preset ensemble (step 110); obtaining m first quantum states obtained after the m first parameterized quantum circuits separately act on an initial quantum state (step 120); obtaining m second quantum states obtained after the quantum channel separately acts on the m first quantum states (step 130); obtaining a quantum state matrix obtained after the second parameterized quantum circuit acts on the initial quantum state, where m diagonal elements of the quantum state matrix as probability values are in a one-to-one correspondence with the m first quantum states to constitute an ensemble (step 140); optimizing parameters of the m first parameterized quantum circuits and the second parameterized quantum circuit by minimizing a loss function, where the loss function is determined based on Holevo information of the quantum channel at the current ensemble, and the Holevo information is determined based on the m second quantum states and corresponding probability values (step 150); and determining the Holevo information, obtained after the loss function is minimized, of the quantum channel as an estimated value of the classical capacity of the quantum channel (step 160).

According to this embodiment of the present disclosure, quantum states in an ensemble and corresponding probabilities thereof are generated by parameterized quantum circuits, so that a Holevo capacity of a quantum channel, that is, the lower bound of a classical capacity of a quantum channel, can be estimated efficiently with few computing resources, which is more instructive in practical use.

In some embodiments, a parameterized quantum circuit may include a number of single-qubit rotation gates and controlled NOT (CNOT) gates. A number of rotation angles form a vector θ, which is an adjustable parameter. The Holevo capacity of the quantum channel [symbol] is estimated to find an ensemble ε={pⱼ, ρⱼ} so that a value of the function χ( [symbol] , ε) is maximal. In this embodiment according to the present disclosure, quantum states {ρⱼ} in an ensemble and probabilities {pⱼ} corresponding to the quantum states are generated by parameterized quantum circuits. Each quantum state ρⱼ can be regarded as a quantum state obtained by each first parameterized quantum circuit Uⱼ(θⱼ) acting on an initial quantum state ρᵢₙᵢₜ, where θⱼ is a parameter of the parameterized quantum circuit. The probability Pi corresponding to each quantum state ρⱼ is a corresponding diagonal element of the quantum state matrix obtained after the second parameterized quantum circuit U_{prob}(θ_{prob}) acts on the initial quantum state ρᵢₙᵢₜ.

In some embodiments, the initial quantum state ρᵢₙᵢₜ may be |0 [symbol] [symbol] 0| that is easy to prepare, and the mathematical form of the initial quantum state is a matrix whose first element at the upper left corner is 1 and the rest elements of which are 0:

$$\vert 0 〉 〈 0 \vert = [ \begin{matrix}1 & 0 & ⋯ & 0 \\ 0 & 0 & ⋯ & 0 \\ ⋮ & ⋮ & ⋱ & ⋮ \\ 0 & 0 & ⋯ & 0\end{matrix} ] .$$

However, it can be understood that other forms of initial quantum states are also possible, which is not limited here.

According to some embodiments, the loss function may be determined based on formula (4):

L=−(S(Σⱼ₌₁^{m}pⱼ [symbol] (ρⱼ))−Σⱼ₌₁^{m}pⱼS( [symbol] (ρⱼ))) formula (4)

Herein, ρⱼ is a j^{th} first quantum state, j=1, 2, . . . , m, [symbol] (ρⱼ) is a quantum state obtained after the quantum channel acts on the quantum state ρⱼ, pⱼ is a j^{th} diagonal element of the quantum state matrix, and S( ) represents a von Neumann entropy. That is, in order to find an ensemble ε={pⱼ,ρⱼ} to make the value of the function [symbol] maximal, the loss function may be equal to [symbol] , so that the ensemble can be found by minimizing the loss function. Alternatively, other forms of loss functions are also possible, which is not limited here.

According to some embodiments, the parameters of the m first parameterized quantum circuits and the second parameterized quantum circuit may be adjusted by means of a gradient descent method to minimize the loss function.

It can be understood that the parameters in the parameterized circuits may be adjusted by any other suitable optimal method, which is not limited here. Moreover, minimizing the loss function does not mean finding an absolute minimum value of the loss function, provided that the minimum value of the loss function can be obtained approximately when the experimental conditions or errors permit.

In an exemplary embodiment according to the present disclosure, the capacity of the quantum channel [symbol] is estimated. First, in step 1, the number of quantum states m in the ensemble is determined, where the value of m can be set arbitrarily. However, it can be understood that a larger value of m leads to a more accurate estimated capacity of the quantum channel, but at the same time, a larger required amount of computation. Then, a parameterized quantum circuit U_{prob}(θ_{prob}) acting on the m-dimensional quantum system is prepared for generating a probability {pⱼ}ⱼ₌₁^{m} in the ensemble, where θ_{prob} is a parameter of the parameterized quantum circuit. That is, the quantum state generated by the parameterized quantum circuit U_{prob}(θ_{prob}) is m-dimensional. For example, for the a-qubit quantum circuit, the quantum state generated by using the circuit is 2^{a}-dimensional. Meanwhile, m n-qubit parameterized quantum circuits {Uⱼ(θⱼ)}ⱼ₌₁^{m} are prepared for generating m quantum states {ρⱼ}ⱼ₌₁^{m} in the ensemble, where {θⱼ}ⱼ₌₁^{m} is a parameter of these parameterized quantum circuits, and n is the number of qubits of the quantum channel [symbol] .

In step 2, for all j=1, 2, . . . , m, the parameterized quantum circuits Uⱼ(θⱼ) are run, and the obtained quantum states are denoted as ρⱼ. The quantum channel [symbol] acts on the quantum states ρⱼ to obtain quantum states [symbol] (ρⱼ).

In step 3, the parameterized quantum circuits U_{prob}(θ_{prob}) are run, and the obtained quantum state matrix is denoted as ρ_{prob}. A j^{th} diagonal element pⱼ of the quantum state matrix ρ_{prob} is taken in turn as a probability corresponding to the quantum state ρⱼ. Thus, the current ensemble ε={pⱼρⱼ}ⱼ₌₁^{m} is obtained.

In step 4, the von Neumann entropy S( [symbol] (ρⱼ)) of the quantum state [symbol] (ρⱼ) is computed, and the von Neumann entropy S(Σⱼ₌₁^{m}pⱼ [symbol] (ρⱼ)) is computed.

In step 5, the loss function L is computed based on formula (4) on a classical computer.

In step 6, the parameters θ_{prob} in the parameterized quantum circuits and all {θⱼ}ⱼ₌₁^{m} are adjusted by means of a gradient descent method or other optimal methods, and steps 2 to 5 are repeated to minimize the loss function L. When the value of the loss function no longer decreases or reaches a set number of iterations, the optimization is stopped and the value of the loss function at this time is denoted as L*, where the corresponding ensemble is ε*={pⱼ*,ρⱼ*}ⱼ₌₁^{m}. The output −L* is used as an estimated value of the Holevo capacity of the quantum channel [symbol] , which is also an estimated value of the classical capacity of the quantum channel Meanwhile, the ensemble ε* is a corresponding ensemble when the estimated value is obtained.

In the embodiment according to the present disclosure, parameterized quantum circuits are used and parameters therein are optimized to obtain an estimated value of the Holevo capacity of the quantum channel as an estimated value of the classical capacity of the quantum channel, where the method according to the embodiment of the present disclosure is flexible enough and imposes no restriction on an input quantum channel. That is, for any quantum channel, the method according to the embodiment of the present disclosure can be implemented and gives an estimated value of its Holevo capacity, and therefore, the method has universality.

In addition, in the embodiment according to the present disclosure, steps 1 to 4 may be implemented on a recent quantum device, or may be simulated by a classical computer, and the Holevo capacity of the input quantum channel can be estimated in both cases. When the method described in this embodiment is run on a quantum device, the input quantum channel to be estimated should be a physically implemented and usable quantum channel. When the method described in this embodiment is simulated on the classical computer, the input quantum channel to be estimated needs to be in a mathematical form corresponding to a physical quantum channel for simulated computation.

In an exemplary application, a Holevo capacity of an amplitude damping channel is estimated by using the method described in the embodiment of the present disclosure. The amplitude damping channel [symbol] is a common type of single-qubit quantum channel, where γ∈[0,1] is a coefficient of the amplitude damping channel. After the single-qubit state ρ is acted on by the amplitude damping channel [symbol] , the obtained quantum state [symbol] (ρ) can be expressed by formula (5):

[symbol]

(ρ)=K₀ρK₀^{†}+K₁ρK₁^{†} formula 5)

Herein,

$${K}_{0} = [ \begin{matrix}1 & 0 \\ 0 & \sqrt{1 - γ}\end{matrix} ] , \\ {K}_{1} = [ \begin{matrix}0 & \sqrt{γ} \\ 0 & 0\end{matrix} ] ,$$

and K₀^{†} and K₁^{†} are respectively the conjugate transpose of K₀ and K₁.

The Holevo capacity of the amplitude damping channel with γ=0.1, 0.3, 0.5, 0.7, 0.9 is separately estimated based on the method described in the embodiment of the present disclosure, where in this application, the number of quantum states in the ensemble is set to 2. Table 2 below shows the comparison between the estimated value obtained by the method according to the embodiment of the present disclosure and the theoretical value (rounded to three decimal places).

TABLE 1

| γ | 0.1 | 0.3 | 0.5 | 0.7 | 0.9 |
|---|---|---|---|---|---|
| Estimated values in this solution | 0.840 | 0.638 | 0.472 | 0.311 | 0.132 |
| Theoretical values | 0.840 | 0.638 | 0.472 | 0.311 | 0.132 |
| Running time in this solution (s) | 2.611 | 2.214 | 2.236 | 2.541 | 2.201 |

It can be learned that the estimated value obtained by the method according to the embodiment of the present disclosure is completely consistent with the theoretical value at three decimal places, which is enough to prove the accuracy of the method according to the embodiment of the present disclosure. In addition, the method according to the embodiment of the present disclosure requires very little time while obtaining an accurate estimated value, so the method has high efficiency and can also be used for estimating a Holevo capacity of a multi-qubit quantum channel.

After an estimated value of a capacity of the quantum channel is obtained, classical information can be transmitted through the quantum channel based on the estimated value. When the classical information is transmitted through the quantum channel, the classical information first needs to be encoded into a quantum state, and then the quantum state is transmitted through the quantum channel. Finally, a receiver decodes the obtained quantum state to obtain the classical information.

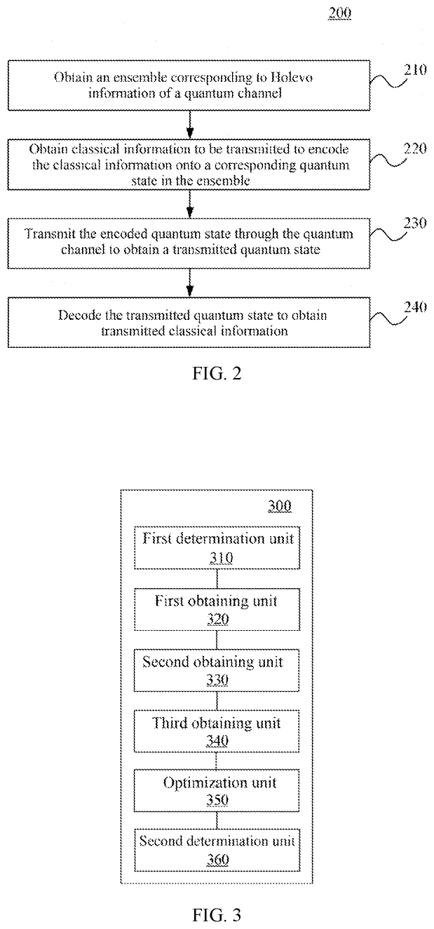

In view of the above, according to an embodiment of the present disclosure, there is further provided an information transmission method 200 based on a quantum channel. As shown in FIG. 2, the method 200 includes: obtaining an ensemble corresponding to Holevo information of the quantum channel (step 210); obtaining classical information to be transmitted to encode the classical information onto a corresponding quantum state in the ensemble (step 220); transmitting the encoded quantum state through the quantum channel to obtain a transmitted quantum state (step 230); and decoding the transmitted quantum state to obtain transmitted classical information (step 240). The ensemble corresponding to the Holevo information is obtained by optimization based on the method described in any one of the above embodiments.

In an example, in the last step of the method described in the above embodiment, an ensemble ε* corresponding to the Holevo capacity of the input quantum channel is obtained. Therefore, when classical information is transmitted, the classical information can be first encoded onto the corresponding quantum state in the ensemble to complete the encoding process before transmission. The Holevo information of the quantum channel is a maximum value at the ensemble, namely, an estimated value of the Holevo capacity of the quantum channel, while the Holevo capacity represents a maximum rate at which classical information can be reliably transmitted by using the quantum channel without using quantum entanglement resources. Therefore, the classical information can be transmitted reliably and efficiently by encoding the classical information to be transmitted onto the quantum state of the ensemble.

According to some embodiments, an optimal solution for distinguishing the quantum states in the ensemble can be computed through semi-definite programming as a solution for decoding the transmitted quantum state. The semi-definite programming has an efficient classical algorithm. Therefore, a solution for transmitting classical information through the estimated quantum channel can be easily obtained based on the output of the method described in the above embodiment, and this solution can reach the estimated Holevo capacity, with very high practicability.

According to an embodiment of the present disclosure, as shown in FIG. 3, there is further provided an apparatus 300 for estimating a capacity of a quantum channel, the apparatus including: a first determination unit 310 configured to determine m n-qubit first parameterized quantum circuits and a second parameterized quantum circuit that acts on an m-dimensional quantum system, where n is the number of qubits of the quantum channel, m is the number of quantum states in a preset ensemble, and m and n are positive integers; a first obtaining unit 320 configured to obtain m first quantum states obtained after the m first parameterized quantum circuits separately act on an initial quantum state; a second obtaining unit 330 configured to obtain m second quantum states obtained after the quantum channel separately acts on the m first quantum states; a third obtaining unit 340 configured to obtain a quantum state matrix obtained after the second parameterized quantum circuit acts on the initial quantum state, where m diagonal elements of the quantum state matrix as probability values are in a one-to-one correspondence with the m first quantum states to constitute an ensemble; an optimization unit 350 configured to optimize parameters of the m first parameterized quantum circuits and the second parameterized quantum circuit by minimizing a loss function, where the loss function is determined based on Holevo information of the quantum channel at the current ensemble, and the Holevo information is determined based on the m second quantum states and corresponding probability values; and a second determination unit 360 configured to determine the Holevo information, obtained after the loss function is minimized, of the quantum channel as an estimated value of the classical capacity of the quantum channel.

Herein, the operations of the foregoing units 310 to 360 of the apparatus 300 for estimating the classical capacity of the quantum channel are respectively similar to the operations of steps 110 to 160 described above. Details are not provided herein again.

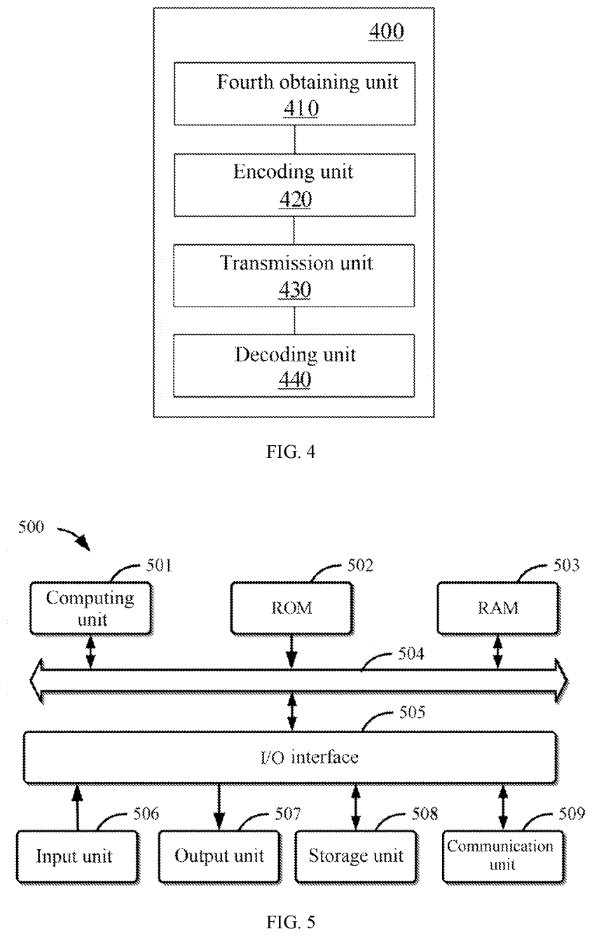

According to an embodiment of the present disclosure, as shown in FIG. 4, there is further provided an information transmission apparatus 400 based on a quantum channel, the apparatus including: a fourth obtaining unit 410 configured to obtain an ensemble corresponding to Holevo information of the quantum channel; an encoding unit 420 configured to obtain classical information to be transmitted to encode the classical information onto a corresponding quantum state in the ensemble; a transmission unit 430 configured to transmit the encoded quantum state through the quantum channel to obtain a transmitted quantum state; and a decoding unit 440 configured to decode the transmitted quantum state to obtain transmitted classical information. The ensemble corresponding to the Holevo information is obtained by optimization based on the method described in any one of the above embodiments.

Herein, the operations of the foregoing units 410 to 440 of the information transmission apparatus 400 based on the quantum channel are respectively similar to the operations of steps 210 to 240 described above. Details are not provided herein again.

According to the embodiments of the present disclosure, there are further provided an electronic device, a readable storage medium, and a computer program product.

Referring to FIG. 5, a structural block diagram of an electronic device 500 that can serve as a server or a client of the present disclosure is now described, which is an example of a hardware device that can be applied to various aspects of the present disclosure. The electronic device is intended to represent various forms of digital electronic computer devices, such as a laptop computer, a desktop computer, a workstation, a personal digital assistant, a server, a blade server, a mainframe computer, and other suitable computers. The electronic device may further represent various forms of mobile apparatuses, such as a personal digital assistant, a cellular phone, a smartphone, a wearable device, and other similar computing apparatuses. The components shown herein, their connections and relationships, and their functions are merely examples, and are not intended to limit the implementation of the present disclosure described and/or required herein.

As shown in FIG. 5, the electronic device 500 includes a computing unit 501, which may perform various appropriate actions and processing according to a computer program stored in a read-only memory (ROM) 502 or a computer program loaded from a storage unit 508 to a random access memory (RAM) 503. The RAM 503 may further store various programs and data required for the operation of the electronic device 500. The computing unit 501, the ROM 502, and the RAM 503 are connected to each other through a bus 504. An input/output (I/O) interface 505 is also connected to the bus 504.

A plurality of components in the electronic device 500 are connected to the I/O interface 505, including: an input unit 506, an output unit 507, the storage unit 508, and a communication unit 509. The input unit 506 may be any type of device capable of entering information to the electronic device 500. The input unit 506 can receive entered digit or character information, and generate a key signal input related to user settings and/or function control of the electronic device, and may include, but is not limited to, a mouse, a keyboard, a touchscreen, a trackpad, a trackball, a joystick, a microphone, and/or a remote controller. The output unit 507 may be any type of device capable of presenting information, and may include, but is not limited to, a display, a speaker, a video/audio output terminal, a vibrator, and/or a printer. The storage unit 508 may include, but is not limited to, a magnetic disk and an optical disc. The communication unit 509 allows the electronic device 500 to exchange information/data with other devices via a computer network such as the Internet and/or various telecommunications networks, and may include, but is not limited to, a modem, a network interface card, an infrared communication device, a wireless communication transceiver and/or a chipset, e.g., a Bluetooth™ device, an 802.11 device, a Wi-Fi device, a WiMAX device, a cellular communication device, and/or the like.

The computing unit 501 may be various general-purpose and/or special-purpose processing components with processing and computing capabilities. Some examples of the computing unit 501 include, but are not limited to, a central processing unit (CPU), a graphics processing unit (GPU), various dedicated artificial intelligence (AI) computing chips, various computing units that run machine learning model algorithms, a digital signal processor (DSP), and any appropriate processor, controller, microcontroller, etc. The computing unit 501 performs the various methods and processing described above, for example, the method 100 or 200. For example, in some embodiments, the method 100 or 200 may be implemented as a computer software program, which is tangibly contained in a machine-readable medium, such as the storage unit 508. In some embodiments, a part or all of the computer program may be loaded and/or installed onto the electronic device 500 via the ROM 502 and/or the communication unit 509. When the computer program is loaded onto the RAM 503 and executed by the computing unit 501, one or more steps of the method 100 or 200 described above can be performed. Alternatively, in other embodiments, the computing unit 501 may be configured, by any other suitable means (for example, by means of firmware), to perform the method 100 or 200.

Various implementations of the systems and technologies described herein above can be implemented in a digital electronic circuit system, an integrated circuit system, a field programmable gate array (FPGA), an application-specific integrated circuit (ASIC), an application-specific standard product (ASSP), a system-on-chip (SOC) system, a complex programmable logical device (CPLD), computer hardware, firmware, software, and/or a combination thereof. These various implementations may include: The systems and technologies are implemented in one or more computer programs, where the one or more computer programs may be executed and/or interpreted on a programmable system including at least one programmable processor. The programmable processor may be a dedicated or general-purpose programmable processor that can receive data and instructions from a storage system, at least one input apparatus, and at least one output apparatus, and transmit data and instructions to the storage system, the at least one input apparatus, and the at least one output apparatus.

Program codes used to implement the method of the present disclosure can be written in any combination of one or more programming languages. These program codes may be provided for a processor or a controller of a general-purpose computer, a special-purpose computer, or other programmable data processing apparatuses, such that when the program codes are executed by the processor or the controller, the functions/operations specified in the flowcharts and/or block diagrams are implemented. The program codes may be completely executed on a machine, or partially executed on a machine, or may be, as an independent software package, partially executed on a machine and partially executed on a remote machine, or completely executed on a remote machine or a server.

In the context of the present disclosure, the machine-readable medium may be a tangible medium, which may contain or store a program for use by an instruction execution system, apparatus, or device, or for use in combination with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

In order to provide interaction with a user, the systems and technologies described herein can be implemented on a computer which has: a display apparatus (for example, a cathode-ray tube (CRT) or a liquid crystal display (LCD) monitor) configured to display information to the user; and a keyboard and a pointing apparatus (for example, a mouse or a trackball) through which the user can provide an input to the computer. Other types of apparatuses can also be used to provide interaction with the user; for example, feedback provided to the user can be any form of sensory feedback (for example, visual feedback, auditory feedback, or tactile feedback), and an input from the user can be received in any form (including an acoustic input, a voice input, or a tactile input).

The systems and technologies described herein can be implemented in a computing system (for example, as a data server) including a backend component, or a computing system (for example, an application server) including a middleware component, or a computing system (for example, a user computer with a graphical user interface or a web browser through which the user can interact with the implementation of the systems and technologies described herein) including a frontend component, or a computing system including any combination of the backend component, the middleware component, or the frontend component. The components of the system can be connected to each other through digital data communication (for example, a communications network) in any form or medium. Examples of the communications network include: a local area network (LAN), a wide area network (WAN), and the Internet.

A computer system may include a client and a server. The client and the server are generally far away from each other and usually interact through a communications network. A relationship between the client and the server is generated by computer programs running on respective computers and having a client-server relationship with each other. The server may be a cloud server, a server in a distributed system, or a server combined with a blockchain.

It should be understood that steps may be reordered, added, or deleted based on the various forms of procedures shown above. For example, the steps recorded in the present disclosure may be performed in parallel, in order, or in a different order, provided that the desired result of the technical solutions disclosed in the present disclosure can be achieved, which is not limited herein.

Although the embodiments or examples of the present disclosure have been described with reference to the accompanying drawings, it should be appreciated that the method, system, and device described above are merely exemplary embodiments or examples, and the scope of the present invention is not limited by the embodiments or examples, but defined only by the granted claims and the equivalent scope thereof. Various elements in the embodiments or examples may be omitted or substituted by equivalent elements thereof. Moreover, the steps may be performed in an order different from that described in the present disclosure. Further, various elements in the embodiments or examples may be combined in various ways. It is important that, as the technology evolves, many elements described herein may be replaced with equivalent elements that appear after the present disclosure.

What is claimed is:

1. A computer-implemented method, the method comprising:
determining m n-qubit first parameterized quantum circuits and a second parameterized quantum circuit that acts on an m-dimensional quantum system, wherein n is the number of qubits of a quantum channel, m is the number of quantum states in a preset ensemble, and m and n are positive integers;
obtaining m first quantum states obtained after the m first parameterized quantum circuits separately act on a first initial quantum state;
obtaining m second quantum states obtained after the quantum channel separately acts on the m first quantum states;
obtaining a quantum state matrix obtained after the second parameterized quantum circuit acts on a second initial quantum state, wherein m diagonal elements of the quantum state matrix as probability values are in a one-to-one correspondence with the m first quantum states to constitute a current ensemble;
optimizing parameters of the m first parameterized quantum circuits and the second parameterized quantum circuit by minimizing a loss function, wherein the loss function is determined based on Holevo information of the quantum channel at the current ensemble, and the Holevo information is determined based on the m second quantum states and corresponding probability values; and
determining the Holevo information, obtained after the loss function is minimized, of the quantum channel as an estimated value of the classical capacity of the quantum channel.

2. The method according to claim 1, wherein the loss function is determined based on the following formula:
$$L = - ( S ( {\sum }_{j = 1}^{m} {p}_{j} 𝒩 ( {ρ}_{j} ) ) - {\sum }_{j = 1}^{m} {p}_{i} S ( 𝒩 ( {ρ}_{j} ) ) )$$
wherein ρⱼ is a j^{th} first quantum state, j=1, 2, . . . , m, [symbol] (ρⱼ) is a quantum state obtained after the quantum channel acts on the quantum state ρⱼ, pⱼ is a j^{th} diagonal element of the quantum state matrix, and S( ) represents a von Neumann entropy.

3. The method according to claim 1, wherein at least one of the first initial quantum state or the second initial quantum state is a quantum state |0 [symbol] [symbol] 0|.

4. The method according to claim 1, wherein the parameters of the m first parameterized quantum circuits and the second parameterized quantum circuit are adjusted based on a gradient descent method to minimize the loss function.

5. A computer-implemented method, comprising:
obtaining an ensemble corresponding to Holevo information of a quantum channel;
obtaining classical information to be transmitted to encode the classical information onto a corresponding quantum state in the ensemble;
transmitting the encoded quantum state through the quantum channel to obtain a transmitted quantum state; and
decoding the transmitted quantum state to obtain transmitted classical information, wherein
the ensemble corresponding to the Holevo information is obtained by performing operations comprising:
determining m n-qubit first parameterized quantum circuits and a second parameterized quantum circuit that acts on an m-dimensional quantum system, wherein n is the number of qubits of the quantum channel, m is the number of quantum states in a preset ensemble, and m and n are positive integers;
obtaining m first quantum states obtained after the m first parameterized quantum circuits separately act on a first initial quantum state;
obtaining m second quantum states obtained after the quantum channel separately acts on the m first quantum states;
obtaining a quantum state matrix obtained after the second parameterized quantum circuit acts on a second initial quantum state, wherein m diagonal elements of the quantum state matrix as probability values are in a one-to-one correspondence with the m first quantum states to constitute a current ensemble;
optimizing parameters of the m first parameterized quantum circuits and the second parameterized quantum circuit by minimizing a loss function, wherein the loss function is determined based on Holevo information of the quantum channel at the current ensemble, and the Holevo information is determined based on the m second quantum states and corresponding probability values; and
determining the Holevo information, obtained after the loss function is minimized, of the quantum channel as an estimated value of a classical capacity of the quantum channel.

6. The method according to claim 5, wherein a mode of distinguishing the transmitted quantum state is determined through semi-definite programming, and the transmitted quantum state is decoded based on the determined mode.

7. The method according to claim 5, wherein the loss function is determined based on the following formula:
$$L = - ( S ( {\sum }_{j = 1}^{m} {p}_{j} 𝒩 ( {ρ}_{j} ) ) - {\sum }_{j = 1}^{m} {p}_{i} S ( 𝒩 ( {ρ}_{j} ) ) )$$
wherein ρⱼ is a j^{th} first quantum state, j=1, 2, . . . , m, [symbol] (ρⱼ) is a quantum state obtained after the quantum channel acts on the quantum state ρⱼ, pⱼ is a j^{th} diagonal element of the quantum state matrix, and S( ) represents a von Neumann entropy.

8. The method according to claim 5, wherein at least one of the first initial quantum state or the second initial quantum state is a quantum state |0 [symbol] [symbol] 0|.

9. The method according to claim 5, wherein the parameters of the m first parameterized quantum circuits and the second parameterized quantum circuit are adjusted based on a gradient descent method to minimize the loss function.

10. An electronic device, comprising:
a memory storing one or more programs configured to be executed by one or more processors, the one or more programs including instructions for causing the electronic device to perform operations comprising:
determining m n-qubit first parameterized quantum circuits and a second parameterized quantum circuit that acts on an m-dimensional quantum system, wherein n is the number of qubits of a quantum channel, m is the number of quantum states in a preset ensemble, and m and n are positive integers;
obtaining m first quantum states obtained after the m first parameterized quantum circuits separately act on a first initial quantum state;
obtaining m second quantum states obtained after the quantum channel separately acts on the m first quantum states;
obtaining a quantum state matrix obtained after the second parameterized quantum circuit acts on a second initial quantum state, wherein m diagonal elements of the quantum state matrix as probability values are in a one-to-one correspondence with the m first quantum states to constitute an ensemble;
optimizing parameters of the m first parameterized quantum circuits and the second parameterized quantum circuit by minimizing a loss function, wherein the loss function is determined based on Holevo information of the quantum channel at the current ensemble, and the Holevo information is determined based on the m second quantum states and corresponding probability values; and
determining the Holevo information, obtained after the loss function is minimized, of the quantum channel as an estimated value of a classical capacity of the quantum channel.

11. The electronic device according to claim 10, wherein the loss function is determined based on the following formula:
$$L = - ( S ( {\sum }_{j = 1}^{m} {p}_{j} 𝒩 ( {ρ}_{j} ) ) - {\sum }_{j = 1}^{m} {p}_{i} S ( 𝒩 ( {ρ}_{j} ) ) )$$
wherein ρⱼ is a j^{th} first quantum state, j=1, 2, . . . , m, [symbol] (ρⱼ) is a quantum state obtained after the quantum channel acts on the quantum state ρⱼ, pⱼ is a j^{th} diagonal element of the quantum state matrix, and S( ) represents a von Neumann entropy.

12. The electronic device according to claim 10, wherein at least one of the first initial quantum state or the second initial quantum state is a quantum state |0 [symbol] [symbol] 0|.

13. The electronic device according to claim 10, wherein the parameters of the m first parameterized quantum circuits and the second parameterized quantum circuit are adjusted based on a gradient descent method to minimize the loss function.
